(19) United States
(12) Patent Application Publication
(10) Pub. No.: US 2026/0193069 A1
(43) Pub. Date: Jul. 9, 2026

(54) EQUIPMENT FOR A PERSON WORKING AT HEIGHT

(71) Applicant: MANITOU BF, ANCENIS (FR)

(72) Inventors: François MELLERIN, ANCENIS (FR); Stéphane TAILLY, ANCENIS (FR)

(21) Appl. No.: 19/131,486

(22) PCT Filed: Dec. 5, 2023
(86) PCT No.: PCT/FR2023/051928

§ 371 Date: May 20, 2025

(30) Foreign Application Priority Data
Dec. 5, 2022 (FR) 2212744

(51) Int. Cl. B66F 11/04; B66F 17/00

(52) U.S. Cl. CPC B66F 11/044; B66F 17/006

(57) ABSTRACT

Machine (1) for working at elevation comprising a lower part (2), a lifting structure (3), a cradle (4) carried by the lifting structure (3), and a unit (5) for controlling the movement of the lifting structure (3) between at least one low position and one high position of the cradle (4), said cradle (4) comprising at least one platform (6) and a guardrail structure in the form of a frame (7) surrounding the platform (6). The cradle (4) comprises a carriage (8) and a guide path (9) for the carriage (8), along which the carriage (8) is movably mounted. The carriage (8) comprises at least one anchoring member and the unit (5) for controlling the movement of the lifting structure (3) is configured to control the movement of the lifting structure (3) depending on the position of the carriage (8) along the guide path (9).

The present invention relates to equipment for a person working at height.

The invention relates, in particular, to equipment for at least one person working at height, said equipment comprising a bottom portion, a lifting structure supported by the bottom portion, a basket-type work platform carried by the lifting structure and a control unit for controlling the movement of the lifting structure at least for a movement of the work platform between a lower position and an upper position, said work platform comprising at least one platform and a guardrail structure in the form of a frame surrounding the platform.

Such equipment is known, as illustrated for example in the patent FR 3 069 532. Operators working on such lifting equipment are generally provided with personal protective equipment by which they are hooked onto the work platform of the lifting equipment. In practice, the personal protective equipment is generally a harness provided with two lanyards, namely a short lanyard in order to reduce the risk of falling from the work platform, in particular when the equipment is moved at high speed, and a longer lanyard with a shock absorber in order to limit injuries in the case of falling from a height. Such lifting equipment, also called mobile elevating work platforms (MEWP), are specifically designed to lift people to a position where they can work at height in complete safety inside the work platform. The MEWPs have not been designed for the purpose of transporting people from one level to another. Exiting the work platform at height does not correspond to an appropriate use. Any person wishing to access the work platform, or exit therefrom, should only do so in the locations provided to this end, i.e. at ground level or on the chassis of the MEWP. There are exceptional cases where the MEWP can be used to access a workplace at height. Exiting the work platform at height can be permitted in the following cases:
when a full risk assessment has clearly demonstrated that this constitutes the safest and most efficient means of accessing a specific location;
when this exit forms part of an official emergency rescue plan.

Currently, there is no satisfactory solution for this type of situation. The known safety devices all have the drawback of requiring a knowledge of personal protective equipment in order to provide a safe means of intervention by the operator.

One object of the invention is to propose lifting equipment having a design which makes it possible to ensure the safety of an operator when the operator exits the work platform positioned at height, irrespective of the design of the personal protective equipment provided on the operator.

A further object of the invention is to propose lifting equipment having a design which makes it possible for an operator to exit and enter the work platform positioned at height without having to be unhooked from the work platform.

A further object of the invention is to propose lifting equipment having a design which permits an operator, who is not familiar with said lifting equipment, to exit and enter the work platform in complete safety.

To this end, the subject of the invention is equipment for at least one person working at height, said equipment comprising a bottom portion, a lifting structure, a basket-type work platform carried by the lifting structure and a control unit for controlling the movement of the lifting structure at least for a movement of the work platform between a lower position and an upper position, said work platform comprising at least one platform and a guardrail structure in the form of a frame surrounding the platform, characterized in that the work platform comprises a carriage and a guide track for guiding the carriage along which the carriage is movably mounted, in that the carriage comprises at least one anchoring member and in that the control unit for controlling the movement of the lifting structure is configured to control the movement of the lifting structure as a function of the position of the carriage along the guide track.

The carriage comprises at least one anchoring member to permit a fastening of personal protective equipment to said anchoring member. Due to the presence of this anchoring member, any type of personal protective equipment can be hooked to said member and the operator does not have to be unhooked in order to enter or exit the work platform. The presence of a carriage makes it possible to have a great freedom of movement, while guaranteeing an authorization of a movement of the lifting structure, and as a result the work platform, solely when the safety conditions are met, due to a movement of the lifting structure, and as a result the work platform, being automatically controlled by the position of the carriage. Controlling the anchoring of personal protective equipment on the carriage indirectly via the position of the carriage makes it possible to guarantee the conditions in which the operator can move around both inside the work platform and outside this work platform.

According to one embodiment of the invention, the equipment for working at height comprises a system for determining a parameter which is representative of the position of the carriage along the guide track and the control unit for controlling the movement of the lifting structure is configured to obtain data provided by said system and to control the movement of the lifting structure as a function of the data provided by said system.

According to one embodiment of the invention, the guide track comprises at least one so-called working area of the carriage and one so-called parking area of the carriage, and the control unit for controlling the movement of the lifting structure is configured so as to permit, in at least one operating mode of the equipment, a movement of the lifting structure in the state of the carriage positioned in the parking area, or one of the parking areas, of the guide track and to prohibit a movement of the lifting structure in the state of the carriage positioned in the working area, or one of the working areas, of the guide track. Thus it is simple to control the options for the movement of the operator, either for example by prohibiting an anchoring of the personal protective equipment to the carriage when the carriage is in the parking area, such that the operator knows that they cannot move around outside the work platform in this parking area of the carriage, or for example by arranging the parking area in a position of the work platform such that the operator, in the state anchored to the carriage by their personal protective equipment, is unable to reach the outside of the work platform.

According to one embodiment of the invention, the equipment comprises, for the or each parking area of the guide track, at least one closing member of said parking area, this closing member being a mobile member which is configured to pass from a closed position, in which any entry or exit of the carriage into or out of said parking area is prevented, to an open position and vice versa. Thus any risk of the carriage returning unintentionally into the parking area is prevented, such that the authorization or, respectively, the prohibition of a movement of the lifting structure, and as a result the work platform, is perfectly controlled.

According to one embodiment of the invention, the equipment comprises a return member for returning the closing member into the closed position.

According to one embodiment, the or at least one of the closing members of the parking area is arranged, in the closed position, on the trajectory followed by the carriage for a movement between the parking area and the or a working area and is arranged, in the open position, at a distance from the trajectory followed by the carriage for a movement between the parking area and the or a working area, this closing member being independent of the movement of the carriage for working at height.

According to one embodiment of the invention, the closing member, which is independent of the movement of the carriage, is a finger and the return member is a spring, said closing finger being arranged in the region of a transition area between the parking area which is capable of being closed by the closing finger and the or a working area of the guide track, this closing finger being arranged, in the closed position, on the trajectory followed by the carriage for a movement between the parking area and the or a working area and being arranged, in the open position, at a distance from the trajectory followed by the carriage for a movement between the parking area and the or a working area, and the spring being configured to return the closing finger into the closed position. Thus it suffices for the operator to manipulate the finger counter to the action of the spring for the passage of the finger from a closed position of the parking area to an open position of the parking area. The release of the finger automatically permits a return of the finger into the closed position of the parking area.

According to one embodiment, the equipment comprises at least one device for detecting and/or visualizing at least the environment of the work platform, at least one actuator for driving the movement of the closing member of the parking area between the closed position and the open position and a drive unit for driving said actuator, said drive unit being configured to control the operation of the actuator as a function of the data provided by the device for detecting and/or visualizing.

According to one embodiment of the invention, the anchoring member, which is integral with the movement of the carriage, has an active anchoring area which is accessible as a function of the position of the carriage along the guide track.

According to one embodiment of the invention, the active anchoring area of the anchoring member is accessible in the state of the carriage positioned in the working area, or one of the working areas, of the guide track and is inaccessible in the state of the carriage positioned in the parking area, or one of the parking areas, of the guide track. Thus the operator knows, without having to think, that when the carriage is in the parking area, an operation outside the work platform is impossible due to the fact that the operator cannot fasten their personal protective equipment. The lifting equipment is thus suitable for any type of operator, including those who are inexperienced.

According to one embodiment of the invention, the anchoring member is a ring and the equipment comprises a sealing member of the ring.

According to one embodiment of the invention, the sealing member of the ring is fixedly mounted on the work platform and is formed by a cover extending opposite the ring to form an access barrier to the ring in the state of the carriage positioned in the parking area, or one of the parking areas, of the guide track. This results in a design which is simple and thus inexpensive.

According to one embodiment of the invention, at least one part of the guide track extends parallel to the support plane formed by the platform, this part of the guide track extending vertically and above one side of the frame or along one side of the frame outside the frame. Thus the carriage can follow the operator, whose personal protective equipment is fastened to the work platform, over practically the entire length of the platform. Preferably, the frame is a rectangular frame and at least one part of the guide track extends along a longitudinal side of the frame. This longitudinal side corresponds to one of the longest sides of the frame.

According to one embodiment of the invention, at least one part of the guide track is formed by a rail forming a longitudinally slotted hollow body, the carriage is arranged inside the rail and the anchoring member protrudes from the slot of said hollow body forming the rail.

According to one embodiment of the invention, the equipment, which comprises an operating mode in which the control unit for controlling the movement of the lifting structure is configured to control the movement of the lifting structure as a function of the position of said carriage along the guide track, comprises a second operating mode in which the control unit for controlling the movement of the lifting structure is configured to control the movement of the lifting structure independently of the position of said carriage along the guide track, said operating modes being selectively activatable, and the equipment comprises an activation member of one or other of the modes. It is thus possible to control forcibly a movement of the lifting structure, if required by the situation.

A further subject of the invention is a method for controlling lifting equipment, characterized in that, as the lifting equipment is of the type mentioned above, said method comprises a step of determining the position of the carriage on the work platform and a step of controlling the movement of the lifting structure as a function of the position of the carriage on said work platform, a movement of the lifting structure being authorized or prohibited as a function of the determined position.

### BRIEF DESCRIPTION OF THE DRAWINGS

The invention will be understood clearly by reading the following description of exemplary embodiments made with reference to the accompanying drawings, in which:

FIG. 1 shows a perspective view of lifting equipment according to the invention;

FIG. 2 shows a perspective view of the work platform;

FIG. 3 shows a perspective view of the guide track/carriage assembly with a detailed view of the carriage in the state of the carriage positioned in a working area;

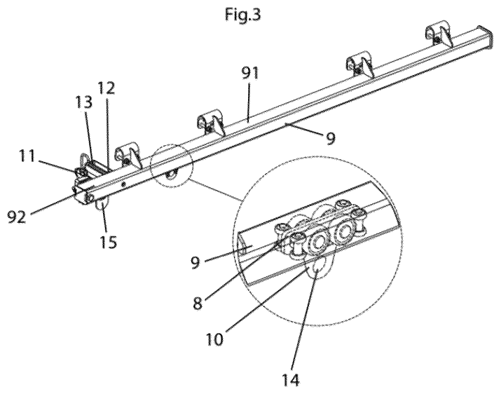

FIG. 4 shows a perspective view of the guide track/carriage assembly with a detailed view of the carriage in the state of the carriage positioned in a parking area;

FIG. 5 shows a detailed perspective view of the closing member and of the system for determining a parameter which is representative of the position of the carriage along the guide track;

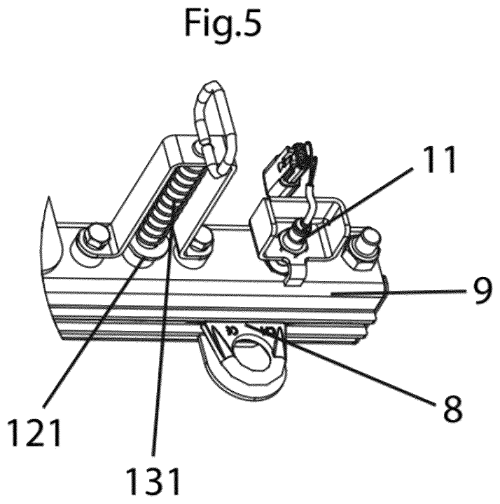

FIG. 6 shows a view of lifting equipment according to a further embodiment of the invention;

FIG. 7 shows a flowchart comprising the steps of a method for an operator to exit the basket according to an embodiment of the invention;

FIG. 8 shows a flowchart comprising the steps of a method for an operator to re-enter the basket according to an embodiment of the invention.

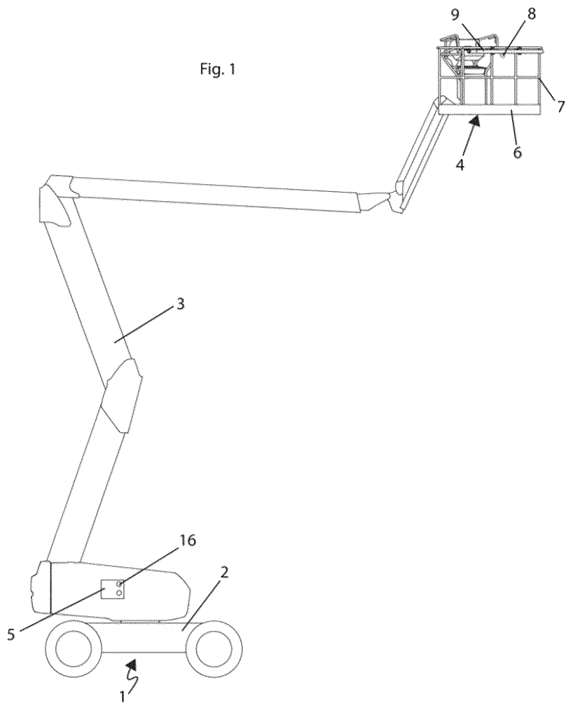

FIG. 1 shows equipment 1 for a person working at height comprising a bottom portion 2, a lifting structure 3, a work platform 4 carried by the lifting structure 3 and a control unit 5.

The bottom portion 2 supports the lifting structure 3. The portion 2 includes a chassis provided with members for connecting to the ground, such as wheels or tracks. The bottom portion 2 can also comprise a tower which is mobile in rotation relative to the chassis according to a so-called vertical axis which is perpendicular to the axes of rotation of the wheels. The lifting structure 3 comprises at least one lifting arm, i.e. a pivoting arm which is pivotably mounted about a so-called horizontal axis parallel to the ground in the state of the bottom portion 2 of the equipment positioned on a planar horizontal surface. This arm can be a telescopic arm. In an equivalent manner, the lifting structure 3 can comprise a plurality of arms, namely for example a lower pivoting arm, an upper arm and a pendular arm. The movements permitted by the arms are known per se and will not be described in more detail hereinafter. In an equivalent manner, the lifting structure 3 can be formed by a scissor-type structure or any other structure 3 permitting a movement at least upwardly and downwardly of the work platform 4, which will be described hereinafter.

The work platform 4 is conventionally in the form of a basket. This work platform 4 is supported by the lifting structure 3. This work platform 4 comprises a platform 6 which is generally in the form of a wire floor, this platform 6 being surrounded by a guardrail structure forming a frame 7. This guardrail structure is essentially formed of uprights and crossmembers connecting said uprights to the upper crossmember, forming a handrail. This handrail forms the upper edge of the frame 7. This frame 7 has in this case a generally rectangular shape, in a similar manner to the platform 6. The lifting equipment also comprises a control unit 5. This control unit 5 is configured to receive, as an input, control signals provided by control members and to control, as an output, actuators such as actuating cylinders or motors. Some of these control members which are formed, for example, by pivoting levers and buttons are integrated in a control console carried by the work platform. The actuation of these control members permits a person present on the platform 6 to control the equipment and, in particular, to control the movement of the lifting structure 3, i.e. the movements of the work platform 4 relative to the chassis of the bottom portion 2. Some of these control members can also make it possible to control the movement of the chassis relative to the ground, the starts/stops, etc.

From the control signals received, the control unit 5 controls the actuators which can be formed by actuating cylinders for the lifting structure 3 or by motors when the purpose is to control a movement of the equipment on the ground. Such a control is well known to those skilled in the art and will not be described in further detail. It should be noted that the movement of the lifting structure 3 can also be generally controlled from the ground and the bottom portion 2 of the equipment can be provided to this end with control members.

The control unit 5 is in the form of an electronic and computer system which comprises, for example, a microprocessor and a working memory. According to a particular aspect, the control unit can be in the form of a programmable controller. In other words, the described functions and steps can be implemented in the form of a computer program or via material components (for example field programable gate arrays). In particular, the functions and steps carried out by the control unit or its modules can be implemented by sets of instructions or computer modules executed in a processor or controller or implemented by dedicated electronic components or components of the programmable logic circuit type (or FPGA which is the English acronym for “field programmable gate array” which corresponds literally to field programmable gate array in situ) or of the application-specific integrated circuit type (or ASIC which is the English acronym for “application-specific integrated circuit” which literally corresponds to an integrated circuit specific to an application). It is also possible to combine the computer parts and the electronic parts. When it is specified that the unit or the means or modules of said unit are configured to carry out a given operation, this means that the unit comprises computer instructions and the corresponding execution means which make it possible to carry out said operation and/or that the unit comprises corresponding electronic components.

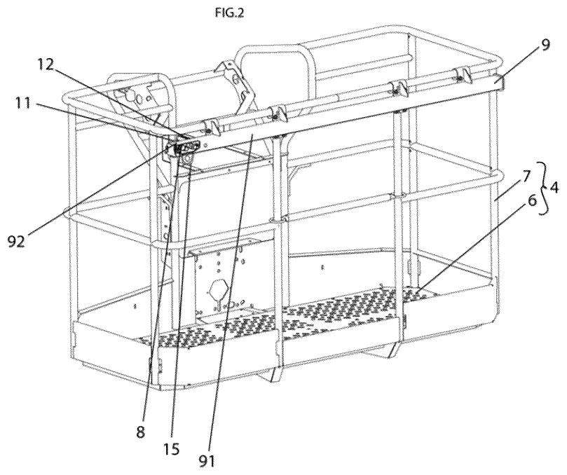

The work platform 4 also comprises a carriage 8 and a guide track 9 for guiding the carriage 8 along which the carriage 8 is movably mounted. Generally, at least one part of the guide track 9 extends parallel to the support plane formed by the platform 6. This part of the guide track 9 extends vertically and above one side of the frame 7, vertically from said side of the frame 7, or along one side of the frame 7 outside the frame 7. It is this second solution which is shown in FIG. 2.

At least one part of the guide track 9 can be formed by a longitudinally slotted rail. In the example shown in FIG. 2, the guide track is a longitudinally slotted rail which extends outside the frame along a longitudinal side of the frame, corresponding in this case to the side of the frame opposing that provided with the control console. The rail extends slightly below the handrail of the frame 7. The carriage 8 is positioned inside the rail.

This carriage 8 comprises a base and wheels. Irrespective of its design and that of the guide track, this carriage 8 is generally moveable by sliding along the guide track 9.

The carriage 8 is provided with at least one anchoring member 10 to permit a fastening of personal protective equipment, in particular the fastening of the lanyard of a harness, to said anchoring member 10. This anchoring member 10 protrudes in this case from the rail via the slot of the rail.

This anchoring member 10 in this case is in the form of a ring, with the inside of the ring forming the active anchoring area 14 of the anchoring member 10.

A carabiner can be fixed to the anchoring member 10 in the region of the active anchoring area 14 of said anchoring member 10. This carabiner can constitute the end of a lanyard, the other end thereof being fastened to the harness of the operator.

In a manner characteristic of the invention, the control unit 5 for controlling the movement of the lifting structure 3 is configured to control the movement of the lifting structure 3 as a function of the position of the carriage 8 along the guide track 9.

Thus the equipment 1 comprises a system 11 for determining a parameter which is representative of the position of the carriage 8 along the guide track 9 and the control unit 5 for controlling the movement of the lifting structure 3 is configured to obtain data provided by said system 11 and to control the movement of the lifting structure 3 as a function of the data provided by said system 11.

This system 11 for determining a parameter which is representative of the position of the carriage 8 along the guide track 9 is formed in this case by a position sensor carried by the rail constituting the guide track 9.

The guide track 9 comprises at least one working area 91 of the carriage 8 and one parking area 92 of the carriage 8.

The control unit 5 for controlling the movement of the lifting structure 3 is configured so as to permit, in at least one operating mode of the equipment 1, a movement of the lifting structure 3 in the state of the carriage 8 positioned in the parking area 92, or one of the parking areas, of the guide track 9 and to prohibit a movement of the lifting structure 3 in the state of the carriage 8 positioned in the working area 91, or one of the working areas, of the guide track 9.

The parking area 92 is formed in this case by a section of the rail which starts at one of the ends of the rail and progresses over a length of the rail at least equal to the length of the carriage, to permit the carriage 8 to be accommodated in this parking area 92. The remainder of the rail forms the working area 91 of the guide track 9.

The guide track 9 thus comprises in this case only one working area 91 and one parking area 92. Naturally, in an equivalent manner, the guide track 9 might have been able to comprise a plurality of parking areas 92 and a plurality of working areas 91 without departing from the scope of the invention. The position sensor forming the system 11 for determining a parameter which is representative of the position of the carriage 8 is arranged in the parking area 92.

In practice, in this operating mode of the equipment when the carriage 9 is detected as being positioned in the parking area of said guide track, by the system 11 for determining a parameter which is representative of the position of the carriage 8 along the guide track 9, the movement of the lifting structure 3 is authorized such that the actuation by the operator of the control members which are provided on the control console generates a movement of the lifting structure 3.

Conversely, when the carriage 9 is detected as being in the or a working area 91, by the system 11 for determining a parameter which is representative of the position of the carriage 8 along the guide track 9, the actuation of the control members of the control console by the operator does not generate any movement of the lifting structure 3.

The movement of the lifting structure 3 is thus prohibited. This prohibition of the movement can permit the operator to consider exiting the work platform 4.

To prevent an undesired passage of the carriage 8 from the parking area 92 to the working area 91 or vice versa, the equipment 1 comprises, for the or each parking area 92 of the guide track 9, at least one closing member 12 of said parking area 92. This closing member 12 is a mobile member which is configured to pass from a closed position, in which any entry or exit of the carriage 8 into or out of said parking area 92 is prevented, to an open position, in which any entry or exit of the carriage into or out of said parking area is authorized, and vice versa.

The equipment 1 also comprises a return member 13 for returning the closing member 12 into the closed position.

In the example shown, the closing member 12, which is independent of the movement of the carriage 8, is a finger 121 and the return member 13 is a spring 131. The closing finger 121 is arranged in the region of a transition area between the parking area 92 which is capable of being closed by the closing finger 121 and a working area 91 of the guide track 9. This closing finger 121 is arranged, in the closed position, on the trajectory followed by the carriage 8 for the passage from a working area to a parking area or vice versa and is arranged, in the open position, at a distance from the trajectory followed by the carriage 8 for the passage from a working area to a parking area or vice versa, and the spring 131 being configured to return the closing finger 121 into the closed position. As a variant, the spring can be replaced by an actuating cylinder.

This finger 121 and the associated spring 131 extend in this case in the vicinity of the end of the rail at right-angles to the longitudinal axis of the rail. In the closed position, the finger protrudes to the inside of the rail through an opening formed in the rail in order to extend transversely to the longitudinal axis of the rail and to prevent the carriage 8 from traveling.

To enable this closing member 12 to pass into the open position, it suffices for the operator to pull on the finger 121 in the direction of removing the finger 121 from the rail, this action being carried out counter to the action of the spring 131 which tends to return the finger inside the rail.

As a result, as soon as the operator releases the closing member 12, it returns to the closed position. Thus the operator does not need to be concerned about the inadvertent entry of the carriage 8 into the parking area, if this entry is not desired by the operator.

To complete the assembly, as described above, the active anchoring area 14 of the anchoring member 10 is accessible as a function of the position of the carriage 8 along the guide track 9.

More specifically, the active anchoring area 14 of the anchoring member 10 is accessible in the state of the carriage 8 positioned in the working area 91, or one of the working areas, of the guide track 9 and is inaccessible in the state of the carriage positioned in the parking area 92, or one of the parking areas, of the guide track 9.

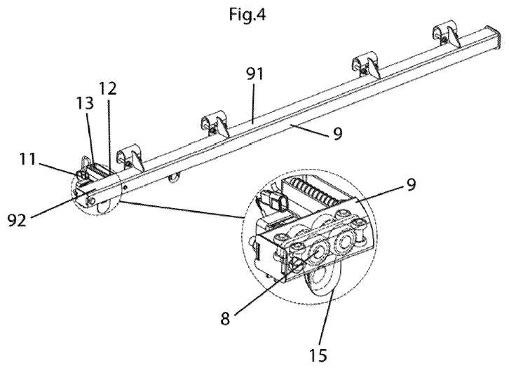

To this end, the equipment 1 comprises a sealing member 15 of the active anchoring part of the anchoring member 10. In the example shown in FIG. 4, the sealing member 15 of the ring is fixedly mounted on the work platform and is formed by a cover extending opposite the ring to form an access barrier to the ring in the state of the carriage 8 positioned in the parking area 92 of the guide track 9.

This cover is in the form of a plate carried by the rail constituting the guide track.

For safety reasons and, in particular, to permit the permanent intervention of an operator from the ground, the equipment 1 comprises a second operating mode in which the control unit 5 for controlling the movement of the lifting structure 3 is configured to control the movement of the lifting structure 3 independently of the position of the carriage 8 along the guide track 9.

The operating modes are selectively activatable and the equipment 1 comprises an activation member 16 of one or other of the operating modes. This activation member 16 is arranged in the region of the bottom portion 2 of the equipment 1.

By default, the equipment 1 is in the operating mode in which the control unit for controlling the movement of the lifting structure is configured to control the movement of the lifting structure as a function of the position of the carriage 8 along the guide track 9.

The operation of the equipment, as described above, can be as follows.

It is assumed that the carriage 8 is in the parking area 92 and that the operator taking up position in the basket is provided with a harness with two lanyards, one thereof being provided with an energy absorber and the other being designed to be fastened to a fixed anchoring point of the work platform.

It is assumed that the operator has decided to go outside the basket to carry out the works.

It is assumed that this operator is inside the basket with their harness attached to one of the anchoring points of the basket by the lanyard without the energy absorber.

The operator actuates the closing member 12 of the parking area in an opening direction of the parking area. The operator slidably moves the carriage to remove it from the parking area and slides the carriage as far as an opening point in the frame, this opening point being able to be formed by a gate or by a lifting handrail if the basket does not have a gate.

Once the removal of the carriage from the parking area has been carried out, the position sensor detects an absence of the carriage in the parking area.

From then on, a signal is transmitted to the control unit and the work platform can no longer move. The operator can thus operate in complete safety.

The closing member 12 in turn has been released by the operator and closes the access to the parking area 92 again, so that the carriage 9 can no longer return to the parking area 92.

The operator hooks the carabiner of the lanyard, provided with an energy absorber, to the carriage in the region of the anchoring member 10 of said carriage 8. The operator unhooks the carabiner of the fixed lanyard attached to one of the fixed anchoring points of the work platform.

The operator can now exit the basket in complete safety. It is noted that during this operation the operator has not at any time been in a configuration in which they would not have been attached to the basket.

It is noted that as long as the carriage has not left the parking area 92, the operator cannot proceed with hooking the lanyard with the energy absorber to the carriage, due to the presence of the sealing member 15 of the active anchoring area 14 of the anchoring member 10 of the carriage 8.

The operator is thus aware that in this position of the carriage 8, in the parking area, they cannot exit the basket.

The equipment 1 as described above is operationally safe, while remaining of simple and inexpensive design.

According to one embodiment, the or at least one of the closing members 12 of the parking area 92 is arranged, in the closed position, on the trajectory followed by the carriage 8 for a movement between the parking area 92 and the or a working area 91 and is arranged, in the open position, at a distance from the trajectory followed by the carriage 8 for a movement between the parking area 92 and the or a working area 91. This closing member 12 is independent of the movement of the carriage 8 for working at height.

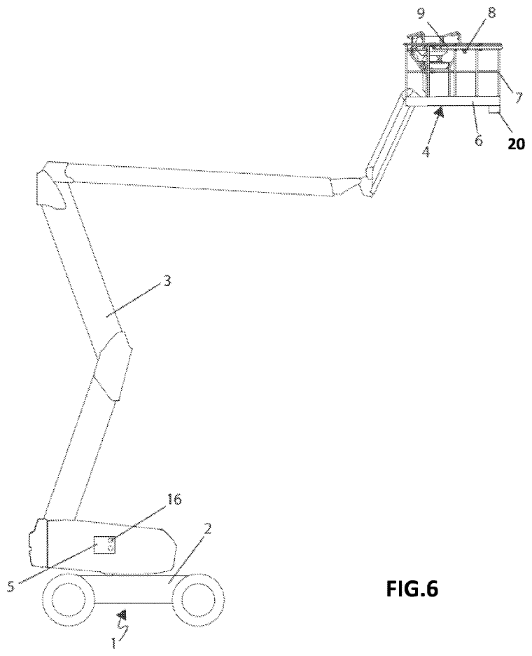

According to one embodiment and as illustrated in FIG. 6, the equipment comprises at least one device 20 for detecting and/or visualizing at least the environment of the work platform 4, also called radar, at least one actuator, such as an actuating cylinder, for driving the movement of the closing member 12 of the parking area 92 between the closed position and the open position and a drive unit for driving said actuator, said drive unit being configured to control the operation of said actuator as a function of data provided by the device 20 for detecting and/or visualizing.

Preferably, the use of the lifeline involves three operators (one person on the ground “operator 3”) and two people in the basket (“operator 1” and “operator 2”). The lifeline is only in use in the working position (active radar system(s) below the basket) and at a minimal height relative to the ground. The sensor of the lifeline detects the presence of the carriage in the parking region.

It is possible to provide that the platform (work platform) and/or the control station on the ground (base station) comprises a display screen configured to display different messages according to the state of the lifeline, preferably with an associated pictogram: the messages can be displayed by being, for example, of the type “machine with lifeline”, “lifeline in use”, “lifeline not in use”, “all work platform movements are prohibited”.

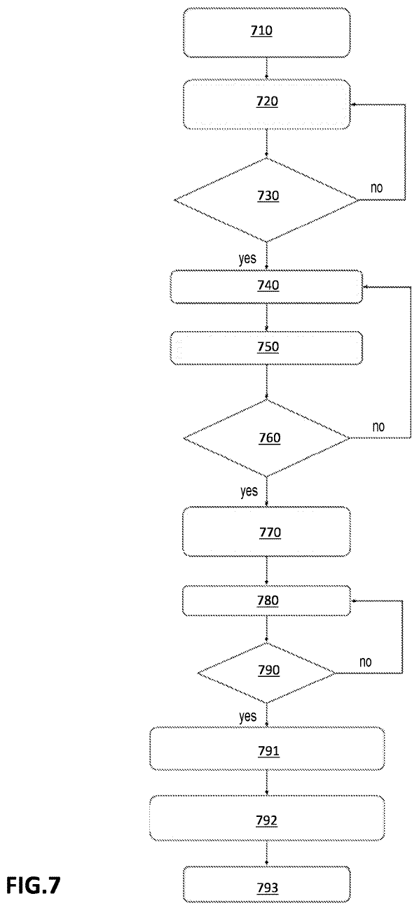

One example of the method is shown below in the form of a flowchart associated with FIG. 7. It is noted that OP1: the operator is monitoring in the basket, OP2: the operator is exiting from the basket and OP3: the operator is monitoring from the ground. In this method, the exit of the operator OP2 from the basket is carried out without a gate condition.

In step 710 the equipment is in the “work” configuration. In step 720 the operator OP1 and the operator OP2 are hooked into the basket. The operator OP3 is in front of the base station of the equipment. The operator OP1 and the operator OP2 carry out movement commands. All of the movements are authorized.

In step 730 it is checked whether the basket approaches an area at a vertical distance of less than 1 meter. If the response is no, the method returns to step 720. If the response is yes, the method passes to step 740 for which a reduction in movement speeds is triggered. Preferably a display of a (pop-up) message such as “proximity to area” is also triggered (step 750).

In step 760 it is checked whether the basket is at a distance of less than 0.3 meters from the target area. If the response is no, the method returns to step 740. If the response is yes, the method passes to step 770, for which all descending and translating movements are prohibited and preferably a display of a (pop-up) message such as “area detected”, is triggered.

In step 780 the operator OP2 actuates a push button to release the carriage. The opening of the parking region is possible under the following two conditions: radar detection and push button action.

In step 790 it is checked whether the removed state of the carriage is detected. If the response is no, the method returns to step 780. If the response is yes, the method passes to step 791 for which at least one of the following actions is triggered: displaying a (pop-up) message on the screens such as “lifeline in use”, switching on flash lights on the basket, switching on a flashing light on the chassis. In step 792, all of the movements are prohibited. The operator OP2 is hooked to the lifeline with their second lanyard. The operator can exit the basket via the gate. In step 793, the operator OP1 is in the basket and the operator OP2 has possibly exited the basket.

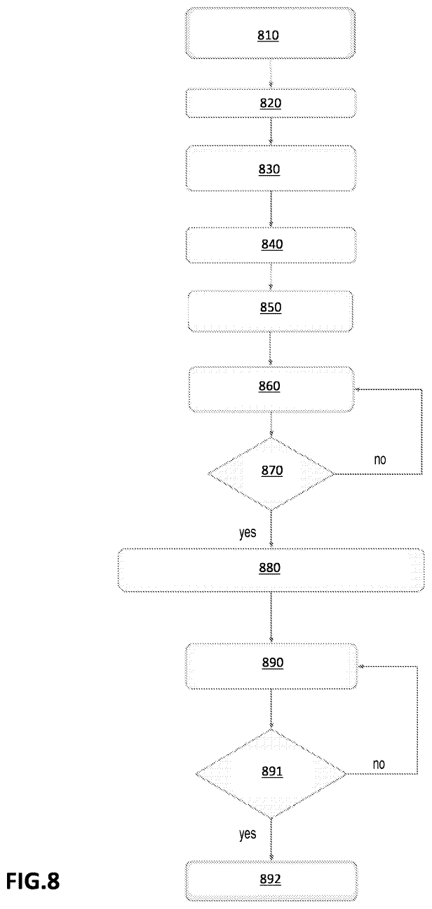

An example of the method is shown below in the form of a flowchart associated with FIG. 8. It is noted that OP1: the operator is monitoring in the basket; OP2: the operator is exiting from the basket and OP3: the operator is monitoring from the ground. In this method, the return of the operator OP2 into the basket is carried out without a gate condition.

In step 810 the operator OP2 is outside the basket, hooked to the lifeline: all of the movements are prohibited.

In step 820 OP2 enters the basket. In step 830 the operator OP2 is hooked to the basket with a first lanyard. In step 840 the operator OP2 is hooked to the basket with a second lanyard of the lifeline. In step 850 the operator OP2 presses on the push button to open the parking region. In step 860 the operator OP2 returns the carriage into the parking region.

In step 870 it is tested whether the carriage is detected as being stored. If the response is no, the method returns to step 860, if the response is yes, the method passes to step 880 according to which at least one of the following actions is commanded to be stopped: flash lights of the basket, flashing lights on the chassis and display of (pop-up) messages. In step 890, the operators OP1 or OP2 can take back the controls (at lower speeds).

In step 891 it is checked whether the vertical distance is greater than 1 meter from the area. If the response is no, the method returns to step 890. If the response is yes, all movements at normal speed are authorized (step 892).

1. Equipment (1) for at least one person working at height, said equipment (1) comprising a bottom portion (2), a lifting structure (3), a basket-type work platform (4) carried by the lifting structure (3) and a control unit (5) for controlling the movement of the lifting structure (3) at least for a movement of the work platform (4) between a lower position and an upper position, said work platform (4) comprising at least one platform (6) and a guardrail structure in the form of a frame (7) surrounding the platform (6), characterized in that the work platform (4) comprises a carriage (8) and a guide track (9) for guiding the carriage (8) along which the carriage (8) is movably mounted, in that the carriage (8) comprises at least one anchoring member (10) and in that the control unit (5) for controlling the movement of the lifting structure (3) is configured to control the movement of the lifting structure (3) as a function of the position of the carriage (8) along the guide track (9).

2. The equipment (1) for working at height as claimed in claim 1, characterized in that it comprises a system (11) for determining a parameter which is representative of the position of the carriage (8) along the guide track (9) and in that the control unit (5) for controlling the movement of the lifting structure (3) is configured to obtain data provided by said system (11) and to control the movement of the lifting structure (3) as a function of the data provided by said system (11).

3. The equipment (1) for working at height as claimed in one of claims 1 or 2, characterized in that the guide track (9) comprises at least one so-called working area (91) of the carriage (8) and one so-called parking area (92) of the carriage (8) and in that the control unit (5) for controlling the movement of the lifting structure (3) is configured so as to permit, in at least one operating mode of the equipment (1), a movement of the lifting structure (3) in the state of the carriage (8) positioned in the parking area (92), or one of the parking areas, of the guide track (9) and to prohibit a movement of the lifting structure (3) in the state of the carriage (8) positioned in the working area (91), or one of the working areas, of the guide track (9).

4. The equipment (1) for working at height as claimed in claim 3, characterized in that the equipment (1) comprises, for the or each parking area (92) of the guide track (9), at least one closing member (12) of said parking area (92), this closing member (12) being a mobile member which is configured to pass from a closed position, in which any entry or exit of the carriage (8) into or out of said parking area (92) is prevented, to an open position and vice versa.

5. The equipment (1) for working at height as claimed in claim 4, characterized in that the equipment (1) comprises a return member (13) for returning the closing member (12) into the closed position.

6. The equipment (1) for working at height as claimed in one of claims 4 or 5, characterized in that the or at least one of the closing members (12) of the parking area (92) is arranged, in the closed position, on the trajectory followed by the carriage (8) for a movement between the parking area (92) and the or a working area (91) and is arranged, in the open position, at a distance from the trajectory followed by the carriage (8) for a movement between the parking area (92) and the or a working area (91), this closing member (12) being independent of the movement of the carriage (8) for working at height.

7. The equipment (1) for working at height as claimed in one of claims 4 to 6, characterized in that the closing member (12), which is independent of the movement of the carriage (8), is a finger (121) and the return member (13) is a spring (131), said closing finger (121) being arranged in the region of a transition area between the parking area (92) which is capable of being closed by the closing finger (121) and the or a working area (91) of the guide track (9), this closing finger (121) being arranged, in the closed position, on the trajectory followed by the carriage (8) for a movement between the parking area (92) and the or a working area (91) and being arranged, in the open position, at a distance from the trajectory followed by the carriage (8) for a movement between the parking area (92) and the or a working area

(91) and the spring (131) being configured to return the closing finger (121) into the closed position.

8. The equipment (1) as claimed in one of claims 4 to 7, characterized in that it comprises at least one device (20) for detecting and/or visualizing at least the environment of the work platform (4), at least one actuator for driving the movement of the closing member (12) of the parking area (92) between the closed position and the open position and a drive unit for driving said actuator, said drive unit being configured to control the operation of the actuator as a function of the data provided by the device (20) for detecting and/or visualizing.

9. Equipment (1) for working at height as claimed in one of claims 1 to 8, characterized in that the anchoring member (10), which is integral with the movement of the carriage (8), has an active anchoring area (14) which is accessible as a function of the position of the carriage (8) along the guide track (9).

10. The equipment (1) for working at height as claimed in claim 9, in combination with one of claims 3 to 8, characterized in that the active anchoring area (14) of the anchoring member (10) is accessible in the state of the carriage (8) positioned in the working area (91), or one of the working areas, of the guide track (9) and is inaccessible in the state of the carriage positioned in the parking area (92), or one of the parking areas, of the guide track (9).

11. The equipment (1) for working at height as claimed in one of claims 1 to 10, characterized in that the anchoring member (10) is a ring and in that the equipment (1) comprises a sealing member (15) of the ring.

12. The equipment (1) for working at height as claimed in claim 11, in combination with one of claims 3 to 8, characterized in that the sealing member (15) of the ring is fixedly mounted on the work platform (4) and is formed by a cover extending opposite the ring to form an access barrier to the ring in the state of the carriage (8) positioned in the parking area (92), or one of the parking areas, of the guide track (9).

13. The equipment (1) for working at height as claimed in one of claims 1 to 12, characterized in that at least one part of the guide track (9) extends parallel to the support plane formed by the platform (6), this part of the guide track (9) extending vertically and above one side of the frame (7) or along one side of the frame (7) outside the frame (7).

14. The equipment (1) for working at height as claimed in one of claims 1 to 13, characterized in that at least one part of the guide track (9) is formed by a rail forming a longitudinally slotted hollow body, in that the carriage (8) is arranged inside the rail and in that the anchoring member (10) protrudes from the slot of said hollow body forming the rail.

15. The equipment (1) for working at height as claimed in one of claims 1 to 14, characterized in that the equipment (1), which comprises an operating mode in which the control unit for controlling the movement of the lifting structure (3) is configured to control the movement of the lifting structure (3) as a function of the position of said carriage (8) along the guide track (9), comprises a second operating mode in which the control unit for controlling the movement of the lifting structure (3) is configured to control the movement of the lifting structure (3) independently of the position of said carriage (8) along the guide track (9), said operating modes being selectively activatable, and the equipment comprises an activation member (16) of one or other of the modes.
